(19) United States
(12) Patent Application Publication
(10) Pub. No.: US 2025/0370841 A1
(43) Pub. Date: Dec. 4, 2025

(54) SYSTEM AND METHOD FOR ROUTING DATASET TRANSMISSIONS USING MACHINE LEARNING MODELS AND ENRICHING DATA USING ARTIFICIAL INTELLIGENCE

(71) Applicant: BANK OF AMERICA CORPORATION, Charlotte, NC (US)

(72) Inventors: Christopher Sitter, Charlotte, NC (US); Jinna Kim, Charlotte, NC (US); Paul Martin Mattison, Sherrills Ford, NC (US); Christopher Perez, Monroe, NC (US); Jo-Ann Taylor, Godalming (GB)

(73) Assignee: BANK OF AMERICA CORPORATION, Charlotte, NC (US)

(21) Appl. No.: 18/731,685

(22) Filed: Jun. 3, 2024

(51) Int. Cl. G06F 11/07

(52) U.S. Cl. CPC G06F 11/0781; G06F 11/0784; G06F 11/0748

(57) ABSTRACT

Systems, computer program products, and methods are described herein for routing data transmissions using machine learning models and enriching data using artificial intelligence. The present disclosure is configured to: receive a dataset comprising a set of elements; rank the received dataset among a plurality of datasets via a machine learning model (MLM), wherein ranking the received dataset determines priority of the received dataset within the plurality; generate a summary of the set of elements within the dataset via an artificial intelligence engine; identify a team via the MLM, based on rank and the summary of the set of elements of the dataset, to process the received dataset; and transmit the dataset to the team identified by the MLM.

### TECHNOLOGICAL FIELD

Example embodiments of the present disclosure relate to routing data transmissions using machine learning models and enriching data using artificial intelligence.

### BACKGROUND

Sorting, routing, and navigating large amounts of data may create delays, mischaracterized diagnosis, and inefficient solutions. Efficient sorting and processing incoming data may be beneficial to overall operations.

Applicant has identified a number of deficiencies and problems associated with to routing data transmissions using machine learning models and enriching data using artificial intelligence. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for routing data transmissions using machine learning models and enriching data using artificial intelligence. In one aspect, a system for routing data transmissions using machine learning and enriching data using artificial intelligence is presented. The system comprising a processing device, at least one non-transitory storage device, and at least one processing device coupled to the at least one non-transitory storage device wherein the at least one processing device is configured to: receive a dataset comprising a set of elements; rank the received dataset among a plurality of datasets via a machine learning model (MLM), wherein ranking the received dataset determines priority of the received dataset within the plurality; generate a summary of the set of elements within the dataset via an artificial intelligence engine; identify a team via the MLM, based on rank and the summary of the set of elements of the dataset, to process the received dataset; and transmit the dataset to the team identified by the MLM.

In some embodiments, individual elements within the dataset may be ranked on priority according to a predetermined set of indicators.

In some embodiments, identification of the team via the MLM may further comprise determining the team from a set of teams compatible with the received dataset based on rank and the summary of the individual elements of the dataset.

In some embodiments, the summary of the set of elements generated by the artificial intelligence engine may provide a context for the received dataset.

In some embodiments, the set of elements may at least partially comprise an incident report.

In some embodiments, the summary of the set of elements may comprise an identifier for potential causes of the incident report.

In some embodiments, the summary of the set of elements may further comprise references to previously encountered datasets associated with the incident report.

In another aspect, a computer program product for routing data transmissions using machine learning models and enriching data using artificial intelligence is presented. The computer program product comprising at least one non-transitory computer-readable medium having computer-readable program code portions embodied therein, the computer-readable program code portions which when executed by a processing device are configured to cause the processor to perform the following operations: receive a dataset comprising a set of elements; rank the received dataset among a plurality of datasets via a machine learning model (MLM), wherein ranking the received dataset determines priority of the received dataset within the plurality; generate a summary of the set of elements within the dataset via an artificial intelligence engine; identify a team via the MLM, based on rank and the summary of the set of elements of the dataset, to process the received dataset; and transmit the dataset to the team identified by the MLM.

In some embodiments, individual elements within the dataset may be ranked on priority according to a predetermined set of indicators.

In some embodiments, identification of the team via the MLM may further comprise determining the team from a set of teams compatible with the received dataset based on rank and the summary of the individual elements of the dataset.

In some embodiments, the summary of the set of elements generated by the artificial intelligence engine may provide a context for the received dataset.

In some embodiments, the set of elements may at least partially comprise an incident report.

In some embodiments, the summary of the set of elements may comprise an identifier for potential causes of the incident report.

In some embodiments, the summary of the set of elements may further comprise references to previously encountered datasets associated with the incident report.

In another aspect, a computer-implemented method for routing data transmissions using machine learning models and enriching data using artificial intelligence is presented. The computer implemented method includes: receiving a dataset comprising a set of elements; ranking the received dataset among a plurality of datasets via a machine learning model (MLM), wherein ranking the received dataset determines the priority of elements within the dataset; generating a summary of the set of elements within the dataset via an artificial intelligence engine; identifying a team based on rank and the summary of individual elements of the dataset via the MLM; and transmitting the dataset to the team identified by the MLM.

In some embodiments, individual elements within the dataset may be ranked on priority according to a predetermined set of indicators.

In some embodiments, identification of the team via the MLM may further comprise determining the team from a set of teams compatible with the received dataset based on rank and the summary of the individual elements of the dataset.

In some embodiments, the summary of the set of elements generated by the artificial intelligence engine may provide a context for the received dataset.

In some embodiments, the set of elements may at least partially comprise an incident report.

In some embodiments, the summary of the set of elements may further comprise references to previously encountered datasets associated with the incident report.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for routing data transmissions using machine learning models and enriching data using artificial intelligence, in accordance with an embodiment of the disclosure;

FIG. 2 illustrates an exemplary machine learning (ML) subsystem architecture in accordance with an embodiment of the disclosure; and

FIG. 3 illustrates a process flow for routing data transmissions using machine learning models and enriching data using artificial intelligence, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users.

In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Transmissions of datasets may be routed to relevant parties based on the content and urgency of said data transmissions. In particular, datasets in the form of an incident report wherein an issue, incident, delay, and/or reported problem are encountered may be comprised of large amounts of data that may be time sensitive. Correctly identifying individuals, groups, teams, and/or entities that may be most relevant to the received dataset may not only reduce delays but also increase efficiency as datasets may be paired with teams most likely to provide solutions.

As the size, complexity, and scope of the received datasets increases, sorting and diagnosing which team may be most relevant to process datasets, particularly datasets in the form of incidents reports, is similarly increasing in levels of difficulty. Multiple factors may determine the priority and importance of received datasets, and sorting through the received datasets to determine which factors may be handled by which teams may create delays as well as becoming unmanageable as complexity increases. This may make selecting and routing the dataset difficult, as the priority and importance of the received dataset may vary between datasets. Processing, understanding, and identifying relevant parties to the received dataset may be a tedious, slow, and difficult process.

With the advent of machine learning and artificial intelligence, sorting, diagnosing, and allocating received datasets may be accomplished in less time and more efficiently. A machine learning model (MLM) may calculate the importance/priority of a received dataset based off a predetermined set of indicators. For instance, datasets that may be associated with safety and regulatory compliance may be prioritized over system delays. After ranking priority of the received dataset, a summary of the elements of the dataset may then be summarized using an artificial intelligence engine. The provided summary may succinctly highlight and describe elements within the received dataset for a later identified team/destination to process the dataset in less time and with less resources. The dataset may then be transmitted to a team/group identified by a form of machine learning. The identified team may then use the summary and ranking of the dataset to process the received dataset.

Accordingly, the present disclosure provides a system, method, and computer-program product for automatically ranking and allocating datasets (e.g., incident reports) to a team using machine learning and artificial intelligence engines. After receiving a dataset, machine learning models may determine the rank in relation to a plurality of datasets. Ranking of the received dataset may be determined based on predetermined identifiers correlating to priority of the received dataset. An artificial intelligence engine may subsequently generate a summary of the set of elements within the received dataset to summarize contents of the dataset. In the case where the dataset is an incident report, the summary may identify potential causes of the incident report, as well as provide references of similar previously encountered datasets. Using the summary and the ranking in relation to the plurality of datasets, a team may then be identified to process the received dataset. Teams may be identified based on the highest compatibility with the received dataset (e.g., teams may be selected based on prior experience and success with previously received datasets). Upon identification, the dataset may be transferred to the identified team.

What is more, the present disclosure provides a technical solution to a technical problem. As described herein, the technical problem includes routing data transmissions to relevant teams and quickly summarizing the received datasets. The technical solution presented herein allows for routing data transmissions using machine learning models and enriching the dataset using artificial intelligence. In particular, routing data transmissions using machine learning models and enriching the dataset using artificial intelligence is an improvement over existing solutions to the routing data transmissions to relevant teams and quickly summarizing the received datasets, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

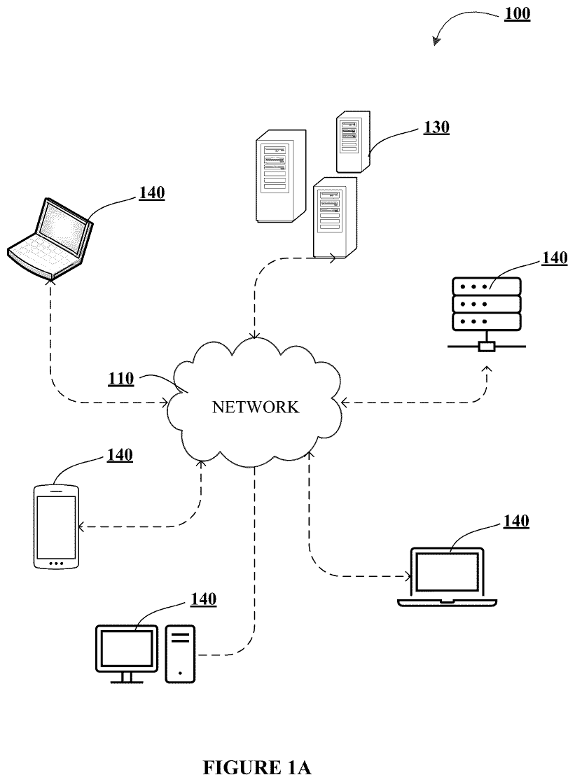

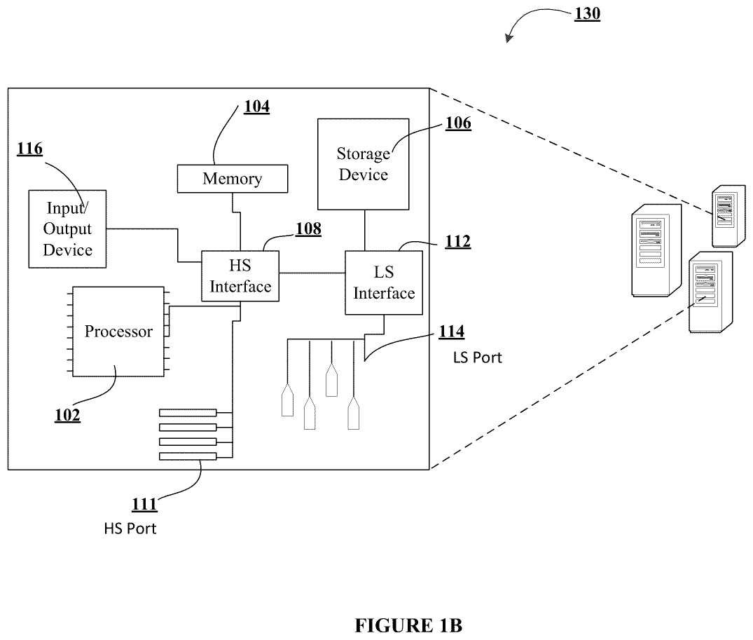

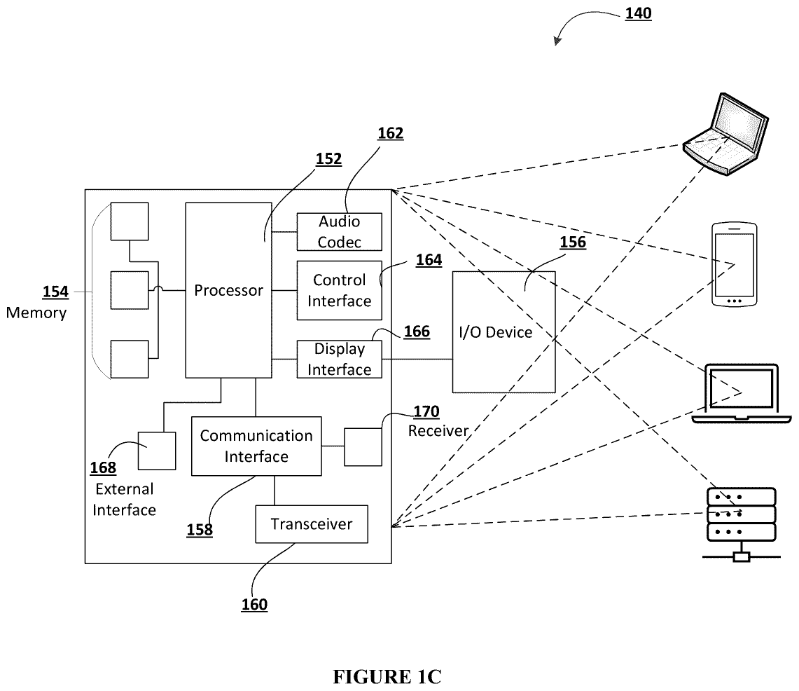

FIGS. 1A-1C illustrate technical components of an exemplary distributed computing environment for routing data transmissions using machine learning and enriching data using artificial intelligence 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

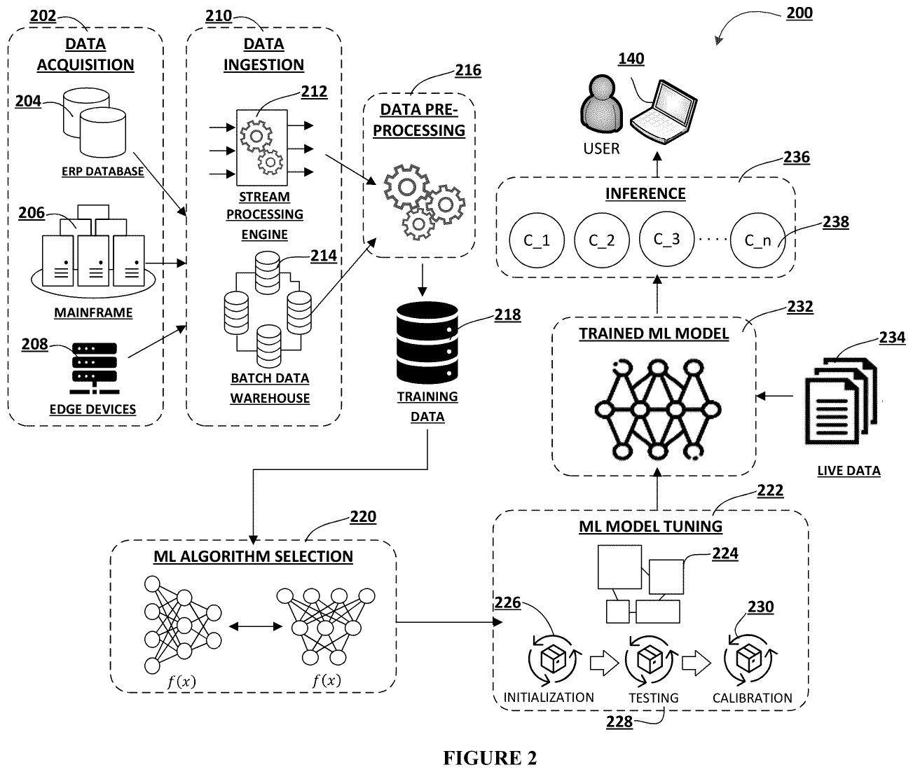

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

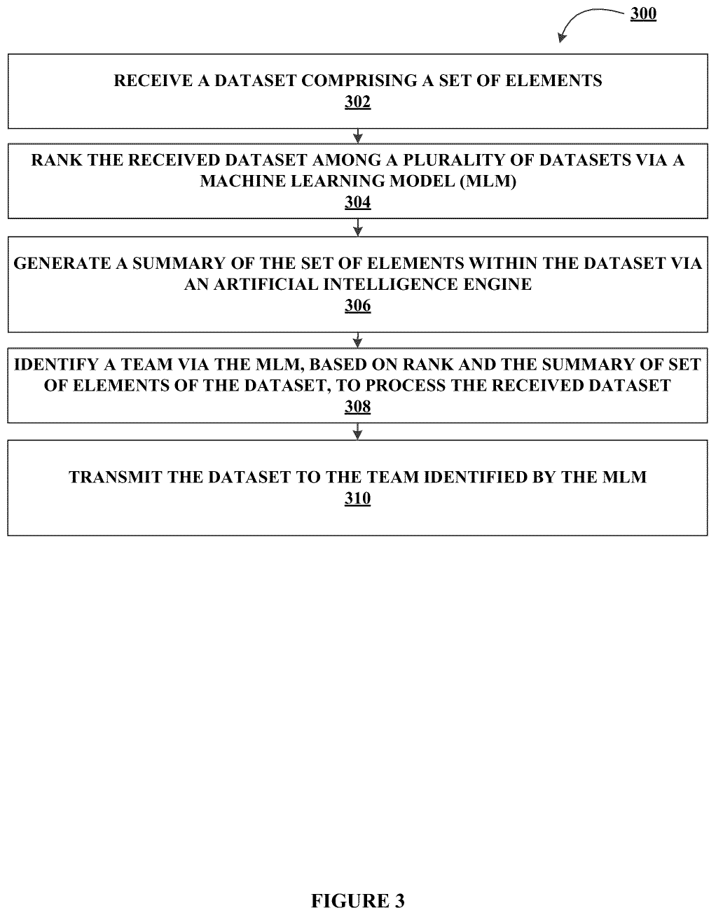

FIG. 3 illustrates a process flow for routing data transmissions using machine learning and enriching data using artificial intelligence. In some embodiments, a system (e.g., similar to one or more of the systems described herein with respect to FIGS. 1A-1C) may perform one or more of the steps of process flow 300. In some embodiments, a generative artificial intelligence engine (e.g., such as the generative AI engine shown in FIG. 2) may perform some or all the steps described in process flow 300.

As shown in block 302, the process flow 300 may include the step of receiving a dataset comprising a set of elements. The received dataset may comprise descriptions, images, quantitative data, qualitative data, identifiers and/or notifications. In some embodiments, the received dataset may be an incident report (e.g., reports, details, and/or documents tracking details associated with a reported issue, problem, and/or incident). For instance, the received dataset may be a description of a non-responding server with an associated identification number and accompanying details describing the impact of the non-responding server. The incident report may include but may not be limited to time stamps, identification of the individual, entity, or group that submitted the incident report, and/or urgency indicators (e.g., labels describing the priority and/or impact of the incident report). The incident report may further provide indicators detailing previously encountered teams attempting to diagnose, solve, interact with, and/or provide partial solutions to the described incident and accompanying incident report. The received dataset may comprise records documenting an incident and subsequent descriptions of impact, urgency, and affected groups, systems, technologies, and/or devices.

In some embodiments, the set of elements within the dataset may be comprised of documents, identifiers, and/or descriptions. For instance, the dataset may comprise supporting documents, screenshots, error identifiers, error codes, error logs, images, audio recordings, recorded comments/notes, locations associated with an error, and the like. The dataset and the set of elements within the dataset may be received from individuals, groups, and/or entities. Further the dataset may be transmitted via email, phone calls, web forms, service software, mobile applications, chat and messaging platforms, social media, and/or monitoring systems.

As shown in block 304, the process flow 300 may include the step of ranking the received dataset among a plurality of datasets via a machine learning model (MLM). The MLM may rank the received dataset in comparison to the plurality of datasets based on a predetermined set of indicators. The predetermined set of indicators may comprise safety, security, operational disruption, regulatory compliance, and quantitative disruptions that may be assigned values to determine the urgency and severity of the received dataset. For example, a received dataset with a set of elements indicating an operational disruption may be ranked below datasets concerning regulatory compliance, safety, and security. The received dataset may also be ranked based on predetermined set of indicators including the impact, urgency, exposure, and severity of the received dataset in comparison to the plurality of datasets. Ranking of the dataset against the plurality of datasets may determine priority of addressing, diagnosing, and/or solving the received dataset.

The plurality of datasets may be arranged and ranked based on the set of elements within the received dataset and the plurality of datasets. For instance, the received dataset may be compared to the plurality of datasets to determine the priority (and/or ranking) of the received dataset. In other words, the MLM may automatically rank the dataset by determining the severity, importance, and priority of the received dataset. In some embodiments, the dataset may be ranked based on the predetermined set of indicators (e.g., safety and security issues hold greater priority).

In some embodiments, the MLM may be a mathematical model trained on data to recognize patterns and predictions without being programmed to perform the task. As described in FIG. 2, the machine learning model may calculate, predict, and/or analyze data to rank the dataset among the plurality of datasets. The MLM may further be used to calculate/identify a team/designated destination, as described in greater detail below. In some embodiments, a first MLM may be used to rank the received dataset among the plurality of datasets, and a second (and in some embodiments, separate) MLM may identify a team based on the rank and summary of individual elements of the dataset.

As shown in block 306, the process flow 300 may include the step of generating a summary of the set of elements within the dataset via an artificial intelligence engine. The generated summary may hold a predetermined maximum length (e.g., the generated summary may be limited by a maximum number of characters, sentences, and/or pages) and highlight the predetermined set of indicators within the dataset. For instance, received datasets may have safety designated as a high priority and a generated summary may include references to any safety concerns associated with the received dataset. Summarizing the received dataset may be performed using an artificial intelligence engine or a general artificial intelligence system.

In some embodiments, the artificial intelligence engine may integrate multiple technologies as described in FIG. 2. The artificial intelligence engine may incorporate multiple artificial intelligence technologies (e.g., machine learning, natural language processing, computer vision) to summarize the received dataset. While the machine learning model may be used to perform a particular task (e.g., ranking the received dataset), the artificial intelligence engine may perform a wider range of tasks, including summarizing the received dataset and the elements within said dataset. The artificial intelligence engine may be adaptable based on the received dataset and may describe a context associated with the received dataset.

In some embodiments, the artificial intelligence engine may be a form of general artificial intelligence. General artificial intelligence may be a form of artificial intelligence with the ability to understand, learn, and apply knowledge at a level comparable to a human. For instance, general artificial intelligence may be used to conduct an increasingly accurate and in-depth summary of the received dataset. The general artificial intelligence may be able to adapt to a changing context, provide comprehensive understanding, and utilize cross-domain knowledge to a greater degree when compared to the artificial intelligence engine.

In some embodiments, the artificial intelligence engine may generate a summary of the set of elements that provides a context for the received dataset. For instance, a context may be generated that describes the environment associated with the dataset by identifying relevant factors associated with the received dataset (e.g., a received dataset in the form of an incident report may have a context in which the incident occurred, which may be provided within the generated summary). The context within the summary generated by the artificial intelligence engine may be provided to an identified team to which the dataset is transmitted to, as described in greater detail below.

In some embodiments, the generated summary of the set of elements may identify potential causes of the incident report. For instance, the summary may comprise elements similar to previously encountered datasets. The previously encountered datasets may be associated with the incident report through the content of the incident report and/or the teams identified to process similar incident reports. Potential causes identified in previously encountered datasets may be provided in the generated summary to aid the identified team in processing the dataset as described in greater detail below. In some embodiments, references to previously encountered datasets associated with the incident report may be provided with the generated summary. The references to previously encountered datasets may provide insight for the identified team to process the received dataset.

As shown in block 308, the process flow 300 may include the step of identifying a team based on rank and the summary of individual elements of the dataset via the MLM. After the received dataset has been ranked by the MLM and the elements within have been summarized by the artificial intelligence engine, a team may be identified by a MLM that may be determined to process and handle the received dataset. For instance, a received dataset designated as a “high” priority and associated with regulatory compliance may be transmitted to a team with regulatory compliance experience that may process the received dataset at a faster rate than other teams within the plurality. In another example, a received dataset designated as a “low” priority and associated with minor service delays may be transmitted to a general maintenance team which may be able to process the dataset but have the dataset waiting in a queue or paused until the general maintenance team has time to address the dataset. Identification of the team may be conducted by matching specialties/expertise of teams to the received dataset and previously encountered datasets by the identified team.

In some embodiments, identification of the team via the MLM may further comprise determining the team from a set of teams compatible with the received dataset based on rank and the summary of the individual elements of the dataset. Identifying the team from the set of teams may be conducted to match previously encountered datasets by individual teams. Further, ranking of the dataset in comparison to the plurality of datasets may determine the level of experience/expertise of the team to process the dataset. For instance, high priority datasets may be processed by teams with comparatively greater levels of experience than teams with lesser levels of experience within the plurality of teams.

As shown in block 310, the process flow 300 may include the step of transmitting the dataset to the team identified by the MLM. Transmission of the dataset to the team identified by the MLM may be conducted upon identification of the team. Transmission of the received dataset may further comprise transmitting the generated summary of the set of elements within the dataset. In some embodiments, the ranking of the received dataset may be transmitted to the identified team. For instance, the generated summary may be transmitted with the received dataset and the ranking (e.g., the dataset may be labeled as a “high” or “low” priority for the team's consideration). Processing of the received dataset may proceed upon transmission of the dataset.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for routing data transmissions using machine learning models and enriching data using artificial intelligence, the system comprising:
a processing device;
at least one non-transitory storage device; and
at least one processing device coupled to the at least one non-transitory storage device, wherein the at least one processing device is configured to:
receive a dataset comprising a set of elements;
rank the received dataset among a plurality of datasets via a machine learning model (MLM), wherein ranking the received dataset determines priority of the received dataset within the plurality;
generate a summary of the set of elements within the dataset via an artificial intelligence engine;
identify a team via the MLM, based on rank and the summary of the set of elements of the dataset, to process the received dataset; and
transmit the dataset to the team identified by the MLM.

2. The system of claim 1, wherein individual elements within the dataset are ranked on priority according to a predetermined set of indicators.

3. The system of claim 1, wherein identification of the team via the MLM further comprises determining the team from a set of teams compatible with the received dataset based on rank and the summary of the set of elements of the dataset.

4. The system of claim 1, wherein the summary of the set of elements generated by the artificial intelligence engine provides a context for the received dataset.

5. The system of claim 1, wherein the set of elements at least partially comprises an incident report.

6. The system of claim 5, wherein the summary of the set of elements identifies potential causes of the incident report.

7. The system of claim 5, wherein the summary of the set of elements further comprises references to previously encountered datasets associated with the incident report.

8. A computer program product for routing data transmissions using machine learning models and enriching data using artificial intelligence, the computer program product comprising at least one non-transitory computer-readable medium having computer-readable program code portions embodied therein, the computer-readable program code portions which when executed by a processing device are configured to cause a processor to perform the following operations: receive a dataset comprising a set of elements;
rank the received dataset among a plurality of datasets via a machine learning model (MLM), wherein ranking the received dataset determines priority of the received dataset within the plurality;
generate a summary of the set of elements within the dataset via an artificial intelligence engine;
identify a team via the MLM based on rank and the summary of the set of elements of the dataset, to process the received dataset; and
transmit the dataset to the team identified by the MLM.

9. The computer program product of claim 8, wherein individual elements within the dataset are ranked on priority according to a predetermined set of indicators.

10. The computer program product of claim 8, wherein identification of the team via the MLM further comprises determining the team from a set of teams compatible with the received dataset based on rank and the summary of the set of elements of the dataset.

11. The computer program product of claim 8, wherein the summary of the set of elements generated by the artificial intelligence engine provides a context for the received dataset.

12. The computer program product of claim 8, wherein the set of elements at least partially comprises an incident report.

13. The computer program product of claim 12, wherein the summary of the set of elements identifies potential causes of the incident report.

14. The computer program product of claim 12, wherein the summary of the set of elements further comprises references to previously encountered datasets associated with the incident report.

15. A computer-implemented method for routing data transmissions using machine learning models and enriching data using artificial intelligence, the method comprising:
receive a dataset comprising a set of elements;
ranking the received dataset among a plurality of datasets via a machine learning model (MLM), wherein ranking the received dataset determines priority of the received dataset within the plurality;
generating a summary of the set of elements within the dataset via an artificial intelligence engine;
identifying a team via the MLM, based on rank and the summary of the set of elements of the dataset, to process the received dataset; and
transmitting the dataset to the team identified by the MLM.

16. The computer-implemented method of claim 15, wherein individual elements within the dataset are ranked on priority according to a predetermined set of indicators.

17. The computer-implemented method of claim 15, wherein identification of the team via the MLM further comprises determining the team from a set of teams compatible with the received dataset based on rank and the summary of the set of elements of the dataset.

18. The computer-implemented method of claim 15, wherein the summary of the set of elements generated by the artificial intelligence engine provides a context for the received dataset.

19. The computer-implemented method of claim 15, wherein the set of elements at least partially comprises an incident report.

20. The computer-implemented method of claim 19, wherein the summary of the set of elements further comprises references to previously encountered datasets associated with the incident report.
